(19) United States
(12) Patent Application Publication
(10) Pub. No.: US 2017/0353820 A1
(43) Pub. Date: Dec. 7, 2017

(54) DEVICE FOR ASSISTING IN BREWING A BEVERAGE

(71) Applicant: Shun-Chieh CHIANG, Taoyuan City (TW)

(72) Inventor: Shun-Chieh CHIANG, Taoyuan City (TW)

(21) Appl. No.: 15/614,068

(22) Filed: Jun. 5, 2017

(30) Foreign Application Priority Data
Jun. 6, 2016 (TW) 105208483
Sep. 30, 2016 (CN) 201610870692.4

(51) Int. Cl. H04W 4/00; A47J 31/52; A47J 31/44; A23F 3/18; H04W 24/00; A23F 3/00

(52) U.S. Cl. CPC H04W 4/005; A47J 31/44; A23F 3/18; A47J 31/52; A23F 3/00; H04W 24/00

(57) ABSTRACT

A device for assisting in brewing a beverage includes a timer, an output unit, a storage unit, and a control unit electrically connected to aforementioned components. The control unit controls, based on timing data stored in the storage unit, the timer to measure a time interval of a procedure of brewing the beverage, and controls, based on measurement of the time interval, the output unit to output the timing result generated by the timer, and to output in sequence plural entries of indication data that are stored in the storage unit, that are associated with the procedure of brewing the beverage, and that include information of purported visual and gustatory perceptions of the beverage at different stages during the procedure of brewing.

### CROSS-REFERENCE TO RELATED APPLICATION

This application claims priorities of Taiwanese Patent Application No. 105208483, filed on Jun. 6, 2016, and Chinese Patent Application No. 201610370692.4 filed on Sep. 30, 2016.

### FIELD

The disclosure relates to a device for indicating assistance information, and more particularly to a device for assisting in brewing a beverage.

### BACKGROUND

Specialty crops include crops used to make beverages. The most common specialty crop drinks include tea, coffee, cocoa, etc. Furthermore, those plants that can be brewed into herb tea, such as chrysanthemum, roselle, jasmine plants, and those plants that can be made into aiyu jelly (also known as ice jelly), grass jelly, etc., are also categorized as specialty crops. Some ingredients of these specialty crops generate unique flavors after being boiled or brewed, making these specialty crop drinks become popular, daily drinks.

However, it is relatively difficult for an ordinary consumer to master the time for achieving the best brewing outcome for the aforementioned specialty crop drinks, and hence these specialty crop drinks are prone to either having an overly short brewing time which may result in insufficiently developed flavors/tastes, or having an overly long brewing time which may result in loss of the otherwise present special flavors/tastes. In either case, the consumer is unable to enjoy the optimal special flavors/tastes of these specialty crop drinks. In particular, due to the fact that different kinds of tea or coffee vary in their associated best brewing time depending on the roasting process and variety of the species, unless lectured or guided by well experienced hobbyists or professionals in these specialty drink fields, an optimal tasting effect for these specialty crop drinks is hardly attainable by an ordinary customer.

### SUMMARY

Therefore, an object of the disclosure is to provide a device for assisting in brewing a beverage that can alleviate at least one of the drawbacks of the prior art.

According to the disclosure, the device includes a control unit, a timer, an output unit and a storage unit.

The timer is electrically connected to the control unit, and is controlled by the control unit to measure a time interval so as to generate a timing result of measurement of the time interval.

The output unit is electrically connected to the control unit, and is controlled by the control unit to output the timing result.

The storage unit is electrically connected to the control unit, and is configured to store timing data that are associated with at least one duration for brewing at least one kind of beverage, and plural entries of indication data that are associated with properties of said at least one kind of beverage during a procedure of brewing said at least one kind of beverage, and that include information of purported visual and gustatory perceptions of said at least one kind of beverage at different stages during the procedure of brewing.

The control unit is configured to control, based on the timing data, the timer to measure the time interval of the procedure of brewing said at least one kind of beverage, and to control, based on the measurement of the time interval, the output unit to output the timing result, and to output in sequence the plural entries of indication data that are associated with the procedure of brewing said at least one kind of beverage.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a first embodiment of a device for assisting in brewing a beverage according to the disclosure;

FIG. 2 is a schematic diagram exemplifying a page containing buttons displayed by the first embodiment of the device according to the disclosure;

FIG. 3 is a schematic diagram exemplifying information outputted by the first embodiment of the device after an “Oriental Beauty” button in FIG. 2 has been activated;

FIG. 4 is a schematic diagram exemplifying information outputted by the first embodiment of the device after a “Start” button in FIG. 3 has been activated;

FIG. 5 is a schematic diagram exemplifying information outputted by the first embodiment of the device after a “Kong Fu teapot” button in FIG. 4 has been activated;

FIG. 6 is a schematic diagram exemplifying information outputted by the first embodiment of the device after a “Covered cup” button in FIG. 4 has been activated;

FIG. 7 is a schematic diagram exemplifying information outputted by the first embodiment of the device after a “Mug” button in FIG. 4 has been activated;

FIG. 8 is a schematic diagram illustrating an embodiment of a primary area of a screen of the first embodiment of the device;

FIG. 9 is a schematic diagram illustrating an embodiment of an entry of the indication data outputted by the first embodiment of the device after a duration for brewing the beverage has elapsed;

FIG. 10 is a schematic diagram illustrating a second embodiment of the device for assisting in brewing a beverage according to the disclosure;

FIG. 11 is a schematic diagram illustrating an embodiment of an entry of the indication data outputted by the second embodiment of the device 10 seconds into brewing a beverage;

FIG. 12 is a schematic diagram illustrating embodiments of an entry of the indication data and key points outputted by the second embodiment of the device 60 seconds into brewing the beverage;

FIG. 13 is a schematic diagram illustrating embodiments of an entry of the indication data and key points outputted by the second embodiment of the device 120 seconds into brewing the beverage;

FIG. 14 is a schematic diagram illustrating embodiments of an entry of the indication data and key points outputted by the second embodiment of the device 180 seconds into brewing the beverage;

FIG. 15 is a schematic diagram illustrating an embodiment of an entry of the indication data indicating that the duration for brewing the beverage has elapsed and being outputted by the second embodiment of the device 210 seconds into brewing the beverage;

FIG. 16 is a schematic diagram illustrating an embodiment of an entry of commentary data that prompts a user to smell and observe color of the beverage and that is outputted by the second embodiment of the device 215 seconds after the brewing of the beverage had started;

FIG. 17 is a schematic diagram illustrating an embodiment of an entry of the commentary data that prompts the user to consume the beverage and that is outputted by the second embodiment of the device 245 seconds after the brewing of the beverage had started;

FIG. 18 is a schematic diagram illustrating an embodiment of an entry of the commentary data that prompts the user to appreciate an aftertaste of the beverage and that is outputted by the second embodiment of the device 275 seconds after the brewing of the beverage had started;

FIG. 19 is a schematic diagram illustrating embodiments of an entry of the commentary data about a first infusion of the beverage and key points outputted by the second embodiment of the device;

FIG. 20 is a schematic diagram illustrating an embodiment of information outputted by the second embodiment of the device after one of the key points which is labeled “Ripe fruit fragrance” at the secondary area in FIG. 19 has been selected;

FIG. 21 is a schematic diagram illustrating an embodiment of an entry of the commentary data outputted by the second embodiment of the device for providing a summary about the beverage;

FIG. 22 is a schematic diagram illustrating an embodiment of an editing interface outputted by the second embodiment of the device after a tab labeled “Text description” has been selected;

FIG. 23 is a schematic diagram illustrating an embodiment of the editing interface outputted by the second embodiment of the device after a tab labeled “Block” has been selected; and

FIG. 24 is a schematic diagram illustrating an embodiment of the editing interface outputted by the second embodiment of the device after a tab labeled “Action” has been clicked.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

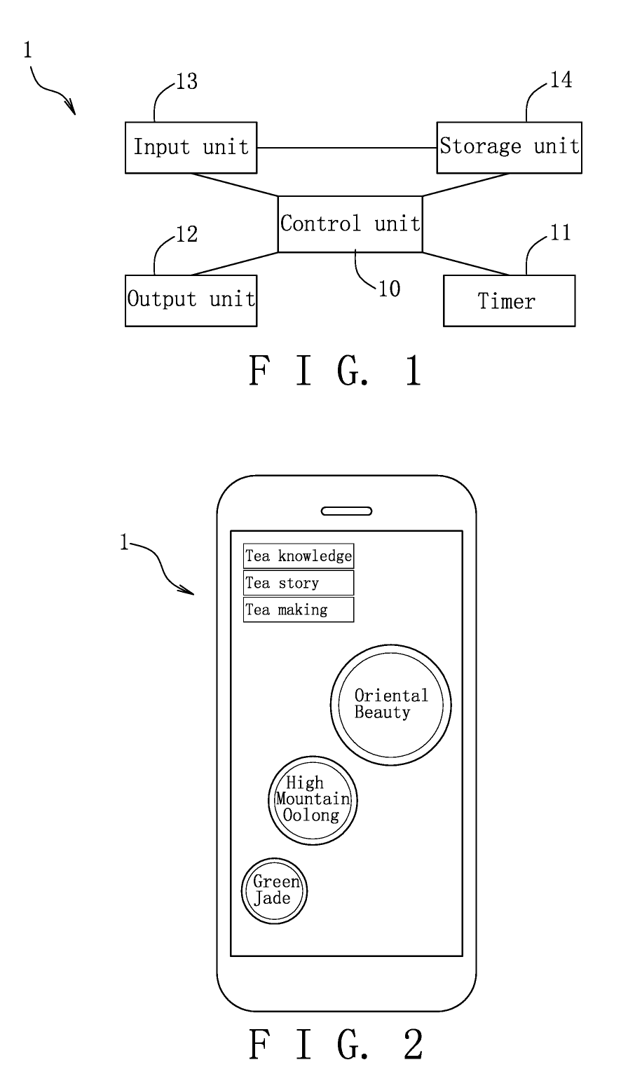

Referring to FIG. 1, a first embodiment of a device 1 for assisting in brewing a beverage according to the disclosure is illustrated. The device 1 includes a control unit 10, a timer 11, an output unit 12, an input unit 13 and a storage unit 14. The control unit 10 is electrically connected to the timer 11, the output unit 12, the input unit 13 and the storage unit 14. The input unit 13 is further electrically connected to the storage unit 14. In some embodiments, the device 1 may be a mobile phone with a specialized mobile app, i.e., a software application designed to run on mobile devices, installed thereon, or an electronic device with a built-in specialized program. In some embodiments, the control unit 10 may include a processor of a mobile phone, but is not limited thereto. The output unit 12 may include at least one of a video playback device which is provided with a screen, or an audio playback device, but is not limited thereto. The input unit 13 may include at least one of a physical button or a virtual button, but is not limited thereto. The storage unit 14 may include a data storage device, such as a solid state disk (SSD) or a flash memory, but is not limited thereto.

The timer 11 is controlled by the control unit 10 to measure a time interval so as to generate a timing result of measurement of the time interval.

The output unit 12 is controlled by the control unit 10 to output the timing result. In this embodiment, the output unit 12 displays the timing result on the screen thereof.

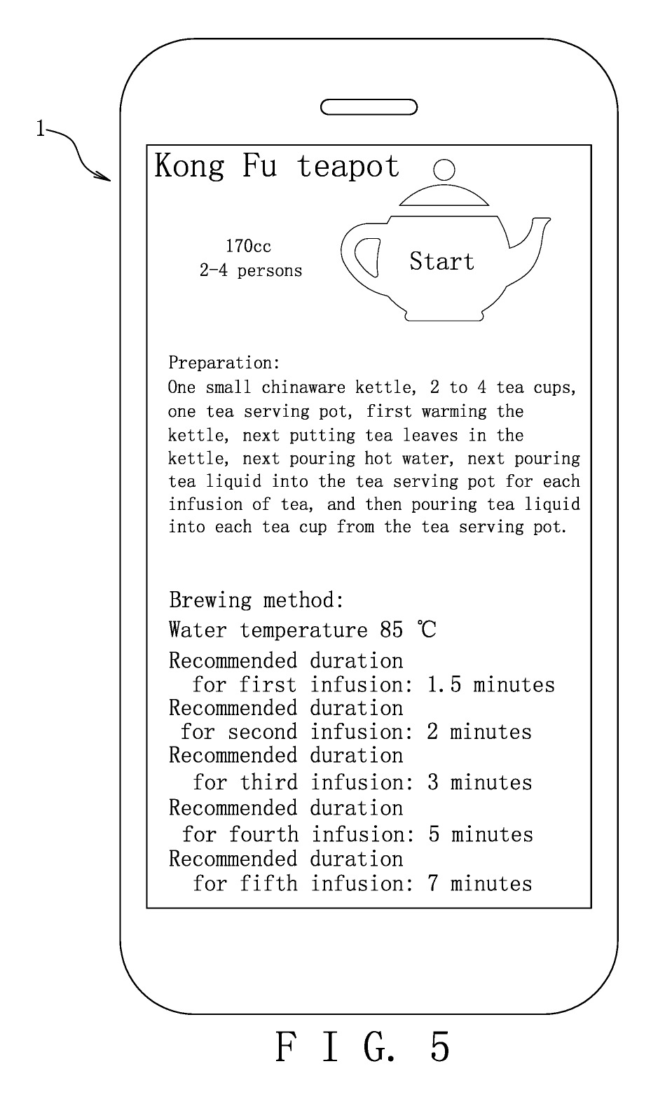

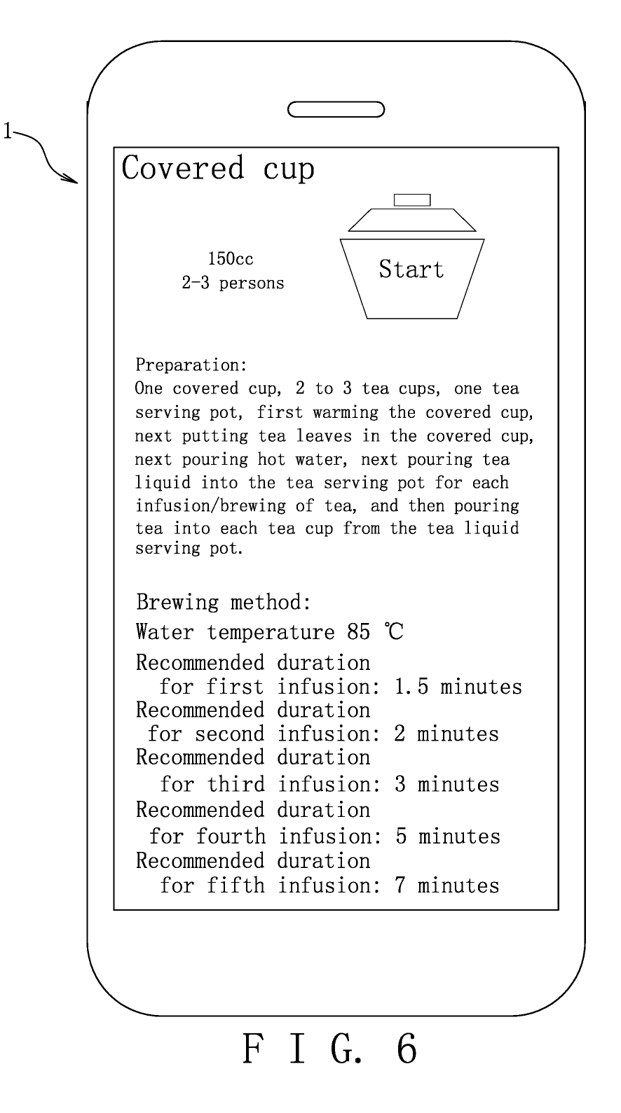

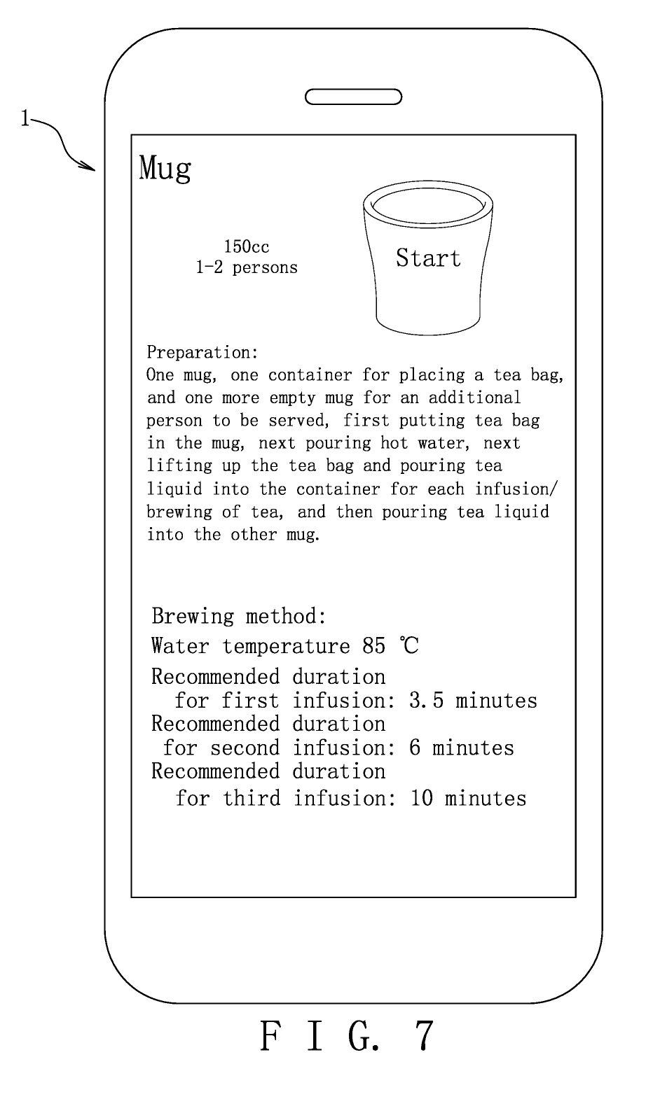

The storage unit 14 is configured to store timing data, plural entries of indication data, plural entries of beverage data and plural entries of container data. The timing data is associated with at least one duration for brewing at least one kind of beverage. Specifically, the timing data includes a plurality of recommended durations for brewing said at least one kind of beverage. Each of the plurality of recommended durations corresponds to a respective infusion (e.g., a first infusion, a second infusion, etc.) of a predetermined amount of said at least one kind of beverage (see FIGS. 5 to 7). The plural entries of indication data are associated with properties of said at least one kind of beverage during a procedure of brewing said at least one kind of beverage. Specifically, the plural entries of indication data include information of purported visual and gustatory perceptions of said at least one kind of beverage at different stages during the procedure of brewing. The different stages may be, for example, different time points at which the properties of said at least one kind of beverage change correspondingly in the procedure of brewing. In one embodiment, the at least one kind of beverage is plural in number, and the plural entries of beverage data are respectively associated with plural kinds of beverages. The plural entries of container data are associated with respective suggested containers, which are different in terms of at least one of material, capacity, size or shape (i.e., factors related to heat transfer).

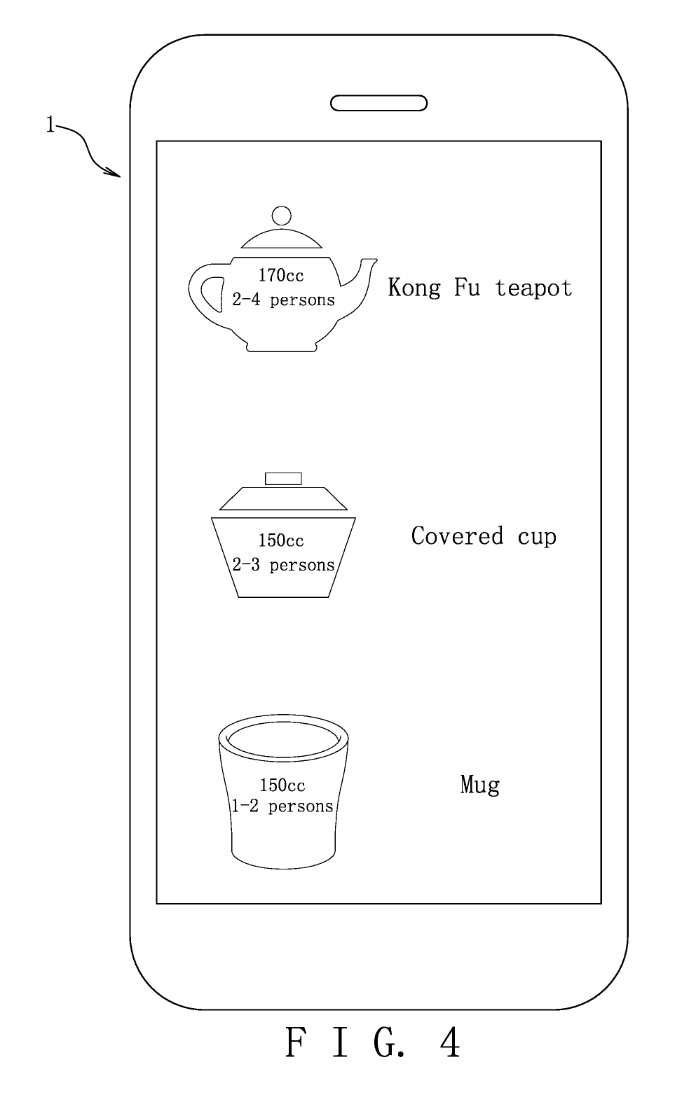

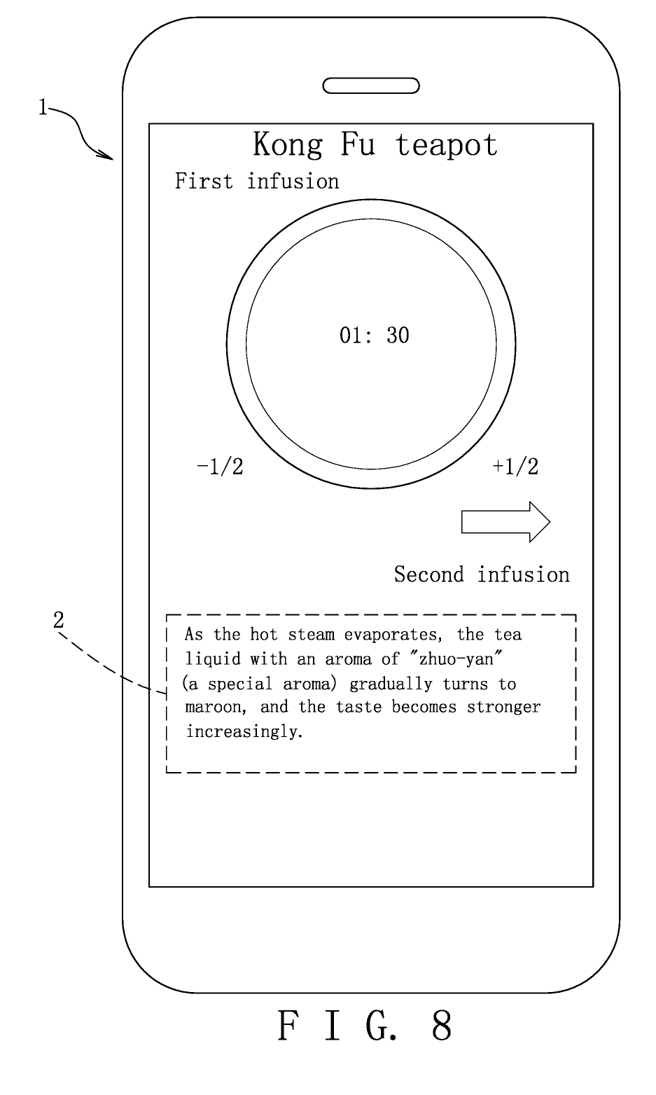

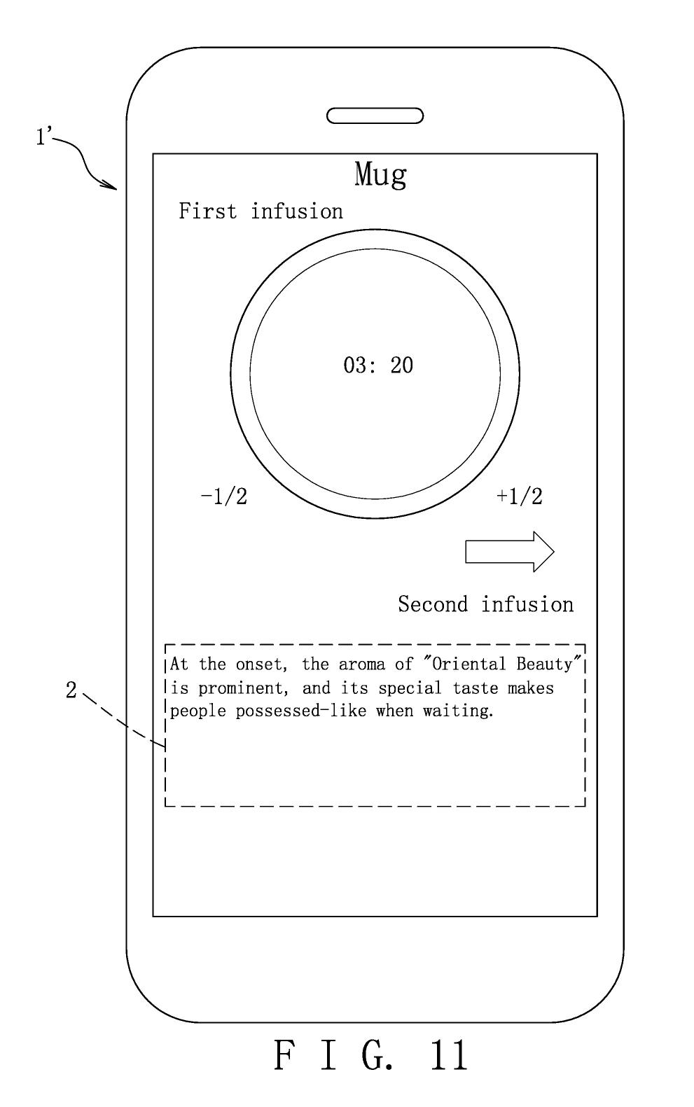

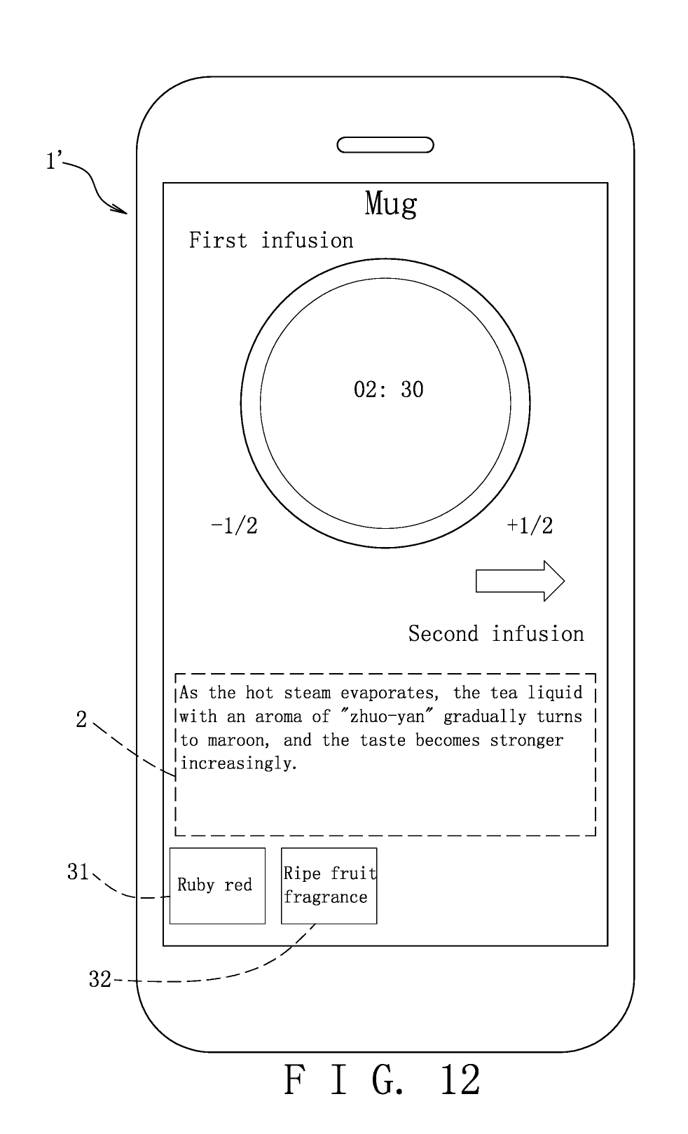

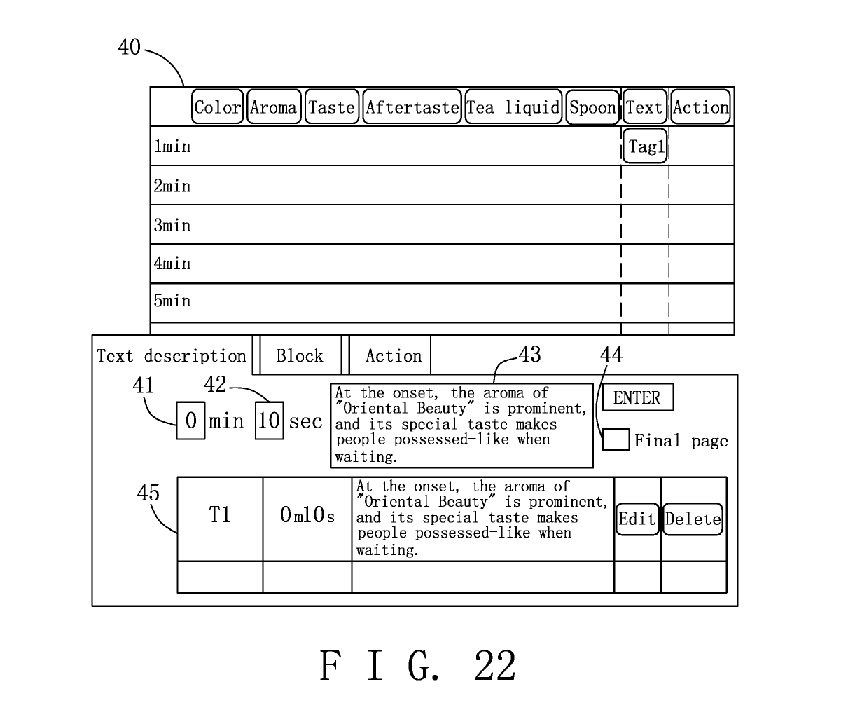

The control unit 10 is configured to control, based on the timing data, the timer 11 to measure the time interval of the procedure of brewing said at least one kind of beverage. The control unit 10 is further configured to control, based on the measurement of the time interval, the output unit 12 to output the timing result (see FIG. 8), and to output in sequence the plural entries of indication data that are associated with the procedure of brewing said at least one kind of beverage (see FIGS. 11 to 14). The control unit 10 is further configured to control the output unit 12 to output information of the suggested containers corresponding to one entry of the beverage data (see FIG. 4). The control unit 10 is further configured to control the output unit 12 to output, for a selected one of the plural kinds of beverage, each associated entry of the container data in combination with a corresponding entry of the timing data (see FIGS. 5 to 7). The control unit 10 is further configured to receive a user input which is inputted via the input unit 13, and to edit, via an editing interface, the timing data and the plural entries of indication data stored in the storage unit 14 based on the user input (see FIGS. 22 to 24). It should be noted that the function of editing the timing data and the plural entries of indication data of the device 1 can be implemented to be only made available to dealers of the at least one kind of beverage or authorized users for the same, and not made available to ordinary users. Therefore, for ordinary users, the device 1 can only be operated for assisting in brewing a beverage, and cannot be operated for editing the timing data and the plural entries of indication data through the editing interface.

The output unit 12 is further configured to output at intervals a description associated with at least one of an appearance of said at least one kind of beverage and a supposed perception of said at least one kind of beverage.

In the following description, said at least one kind of beverage is exemplified by tea, but is not limited thereto.

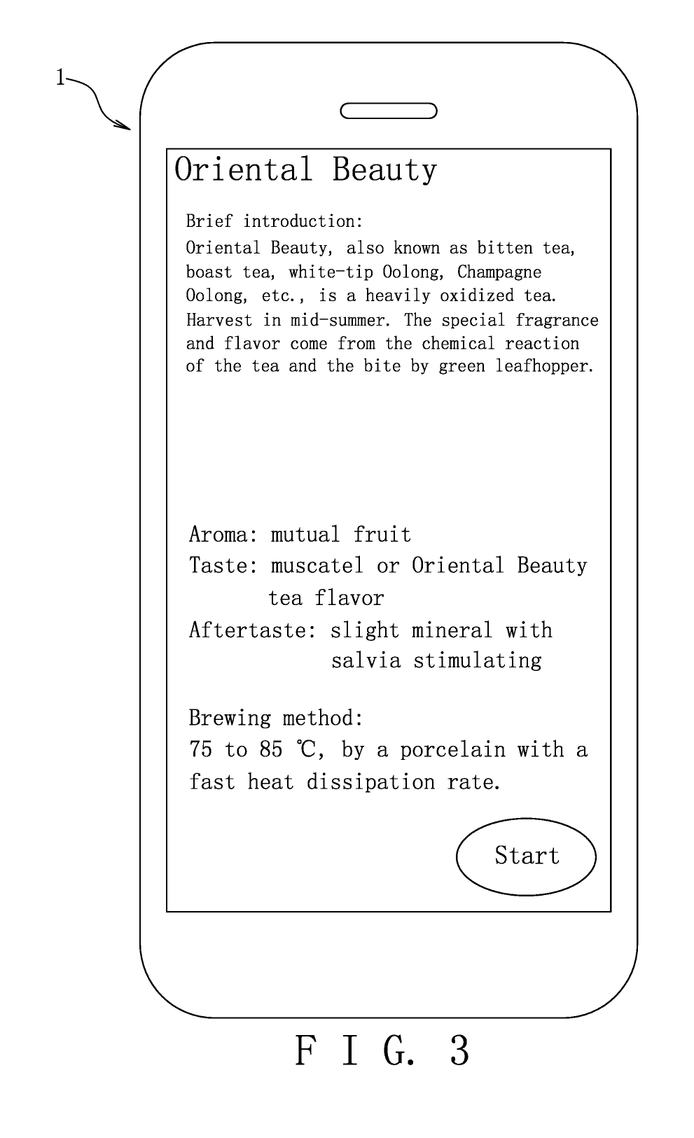

Referring to FIGS. 2 and 3, an example of operating the first embodiment of the device 1 is shown. A page displayed on the screen mainly shows buttons for accessing the related beverage data of tea and/or herbal drinks, such as “Oriental Beauty”, “High Mountain Oolong” or “Green Jade”, etc., as shown in FIG. 2. When one of the buttons is operated, the corresponding beverage data is provided. For example, if an “Oriental Beauty” button is touched, the screen will provide the beverage data, such as a brief introduction, an aroma description, a taste (or flavor) description, an aftertaste description and a brewing method for “Oriental Beauty”, as well as a “Start” button as shown in FIG. 3. At this moment, if the “Start” button is touched, the screen will show an image as shown in FIG. 4. In addition, in the present embodiment, the page in FIG. 2 may also provide buttons which when touched furnish a variety of information about teas on the screen, such as “Tea Knowledge” that introduces the origin and usage of tea, “Tea Story” that provides the anecdotal history of tea, and “Tea Making” that introduces the history and modern ways of making tea.

Referring to FIGS. 4 to 7, an example of operating the first embodiment of the device 1 for assisting in brewing a particular kind of tea, such as Oriental Beauty, is illustrated. FIG. 4 illustrates the information of the suggested containers for Oriental Beauty displayed on the screen. Each of FIGS. 5 to 7 illustrates detailed preparations corresponding to brewing Oriental Beauty and the recommended duration for each infusion thereof by using a different type of the suggested containers, i.e., Kong Fu teapots, covered cups or mugs.

Referring to FIG. 8, in this embodiment where a Kong Fu teapot is selected as the container for brewing Oriental Beauty, the screen is configured to display one of the plural entries of indication data on a primary area 2 of the screen. The storage unit 14 is further configured to store a plurality of first timing threshold values (e.g., 10 seconds, 60 seconds, 120 seconds and 180 seconds) corresponding respectively to the different stages during the procedure of brewing and corresponding respectively to the plural entries of indication data. The control unit 10 is further configured to control, when it is determined that the time interval measured by the timer 11 has reached one of the first timing threshold values, the screen to display a corresponding one of the plural entries of indication data on the primary area 2 of the screen. Each of the plural entries of indication data displayed on the primary area 2 of the screen is presented in a manner of at least one of text, a figure or a motion picture.

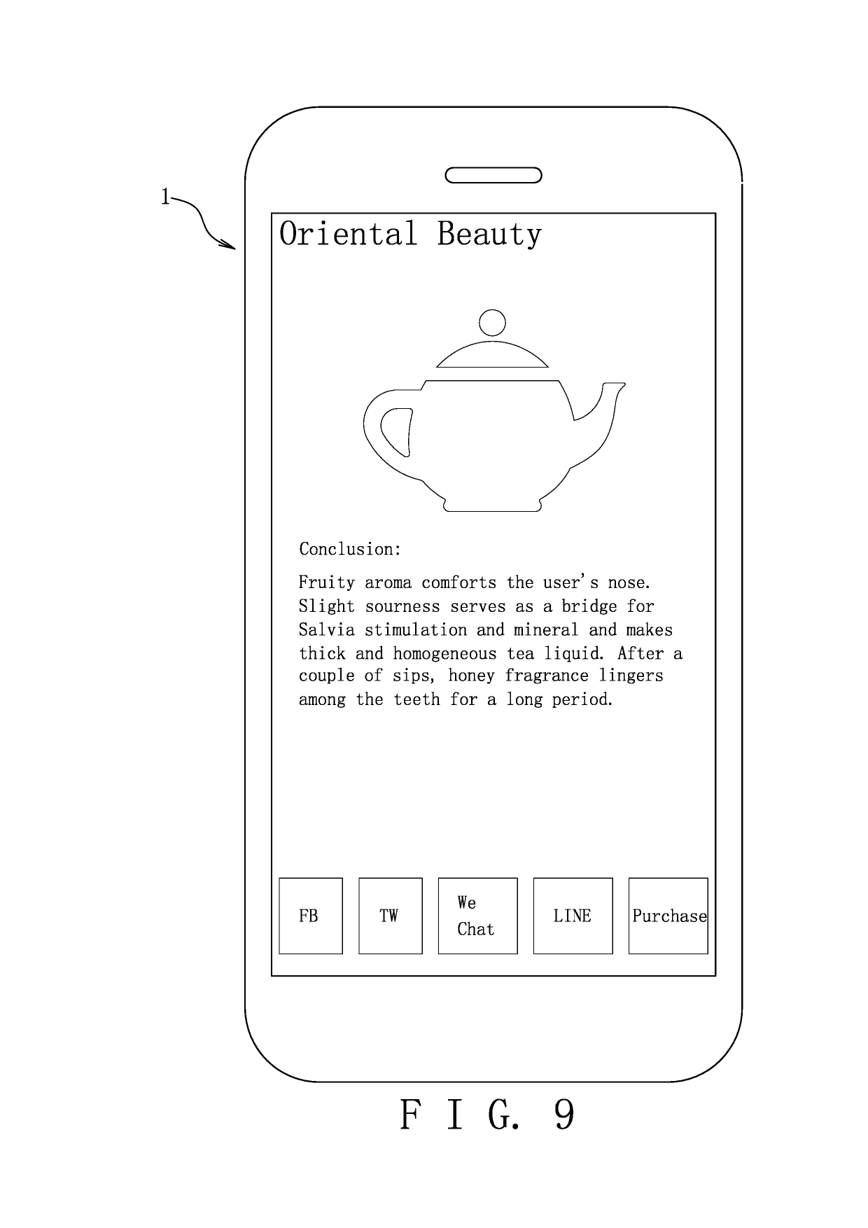

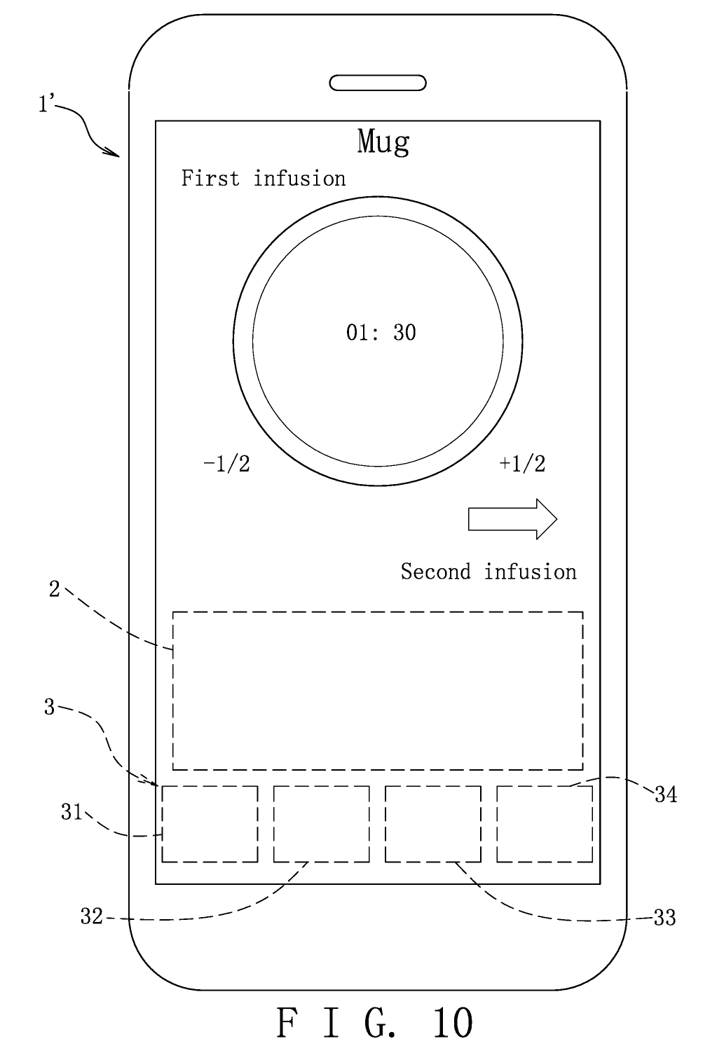

When the procedure of brewing (for one infusion) has finished, i.e., the duration for brewing the tea has elapsed and the plural entries of indication data having been displayed sequentially (only one is exemplarily displayed in FIG. 8), the output unit 12 of the first embodiment of the device 1 outputs an image as exemplified in FIG. 9. The image includes a conclusion about a comment of the tea thus brewed, and a hyperlink which leads to one of a social networking site and an online store carrying the tea (e.g., Oriental Beauty). Therefore, users can share their experience of the tea at the social networking site or purchase the tea at the online store.

Referring to FIG. 10, a second embodiment of a device 1′ for assisting in brewing a beverage is illustrated. The second embodiment of the device 1′ is similar to the first embodiment, but is different in aspects explained in the following descriptions.

The output unit 12 is configured to display at least one key point of each of the plural entries of indication data on a secondary area 3 of the screen. Specifically speaking, the secondary area 3 includes a plurality of blocks 31-34 that are separated from each other, and that are to display respectively the key points of the plural entries of indication data. The storage unit 14 is further configured to store a plurality of second timing threshold values corresponding respectively to the different stages during the procedure of brewing and corresponding respectively to the plural entries of indication data. The second timing threshold values are identical to the first timing threshold values in this embodiment, but in other embodiments, may be distinct from but relevant to the first threshold values. The control unit 10 is configured to control, when it is determined that the time interval measured by the timer 11 has reached one of the second timing threshold values, the screen to display the key point of the corresponding one of the plural entries of indication data on one of the blocks 31-34 of the secondary area 3 of the screen. In one embodiment, when it is determined that the time interval measured by the timer 11 has reached one of the second timing threshold values, the control unit 10 is further configured to control the screen to adjust a shade of color or brightness of one of the blocks 31-34 of the secondary area 3 of the screen. In other words, the key point of one of the plural entries of indication data and the one of the plural entries of indication data are respectively displayed on the secondary and primary areas 3 and 2 of the screen when the time interval measured by the timer 11 has reached a respective one of the first (or second) timing threshold values. The key points displayed on the blocks 31-34 include at least one of description of a color of the beverage (e.g., Oriental Beauty), description of a smell of the beverage (or aroma), description of a taste of the beverage, description of an aftertaste of the beverage, description of a texture of a tea liquid (i.e., the beverage), or description of a smell left in a container for containing the beverage (e.g., at a portion of the container such as a bottom or a rim thereof). The key point of each of the plural entries of indication data displayed on the secondary area 3 of the screen is presented in a manner of at least one of text, a figure or a motion picture. In one embodiment, the control unit 10 is configured to receive the user input which is inputted via the input unit 13, and to edit, via the editing interface (see FIGS. 22 to 24), the key point of each of the plural entries of indication data to be displayed on the secondary area 3 of the screen based on the user input, and the shades of color or brightness of the blocks 31-34 of the secondary area 3 of the screen based on the user input.

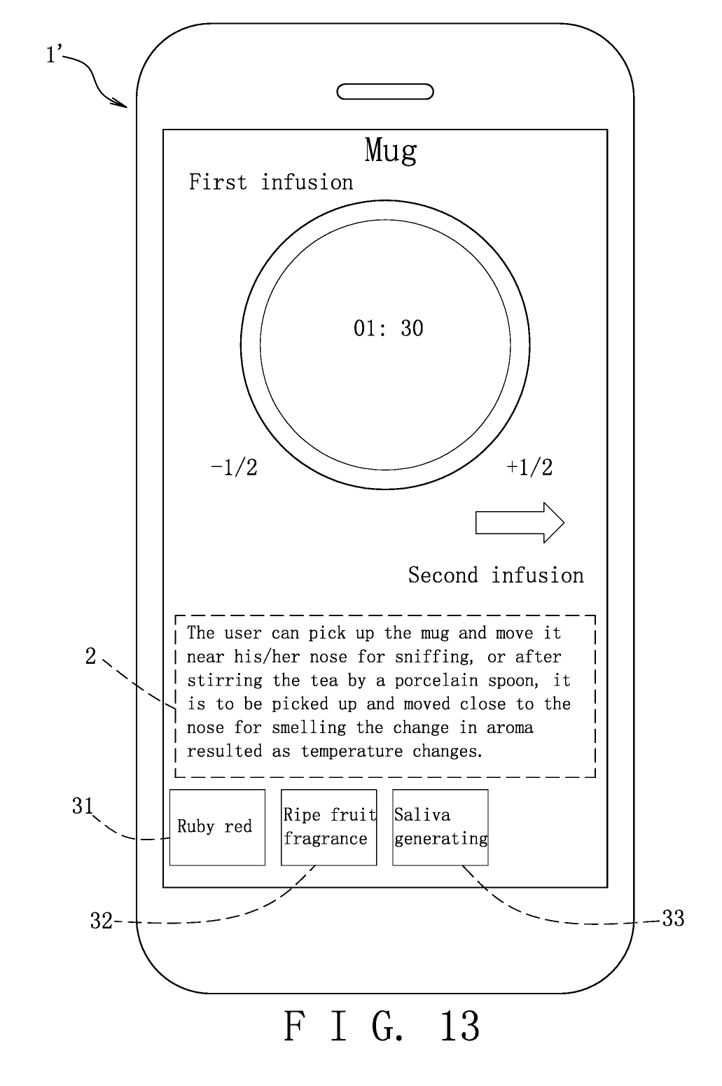

Furthermore, for each of the plural entries of indication data, any corresponding key point and the entry of indication data can be implemented to be displayed on the screen simultaneously (such as the embodiment shown in FIGS. 12 to 14) or sequentially. Taking sequential display as an example, at first, an entry of the indication data for the tea is displayed on the primary area 2 of the screen, and then one key point corresponding to the entry of the indication data for the tea is subsequently displayed on one of the blocks 31-34 of the secondary area 3 of the screen. In this example, each of the second timing threshold values may be the respective one of the first timing threshold values but shifted by a preset time period (e.g., one or several seconds).

In addition, the storage unit 14 is further configured to store an adjustment duration. The input unit 13 is configured to be operated to enable the control unit 10 to access the adjustment duration. Subsequent to accessing the adjustment duration, the control unit 10 is enabled to, based on different operations of the input unit 13 (for example, an icon “+1/2” or “−1/2” shown in FIG. 8 is actuated), add the adjustment duration to the duration for brewing said at least one kind of beverage (for a respective infusion) to serve as the timing data, or subtract the adjustment duration from the duration for brewing said at least one kind of beverage (for the respective infusion) to serve as the timing data. The storage unit 14 is further configured to store additional indication data that corresponds to the duration for brewing said at least one kind of beverage extended by the adjustment duration, and to store additional indication data that corresponds to the duration for brewing said at least one kind of beverage shortened by the adjustment duration.

Taking brewing Oriental Beauty by using a mug as an example, assuming that the device 1′ for assisting in brewing a beverage displays the recommended duration for a first brew to be 3 minutes and 30 seconds (3:30). When the icon “+1/2” (see FIG. 11) which indicates the adjustment duration of a half-minute extension is actuated, the control unit 10 adds 3 minutes and 30 seconds by half a minute so as to make the duration for brewing become 4 minutes. When the tea is brewed based on the duration thus extended, the brewing result will render a thicker taste, and the aroma and color will be more prominent, while the taste becomes slightly sourer, with the resultant overall taste having a richer level and depth. At this moment, the additional indication data that corresponds to the duration for brewing as extended by the adjustment duration is displayed in the primary area 2, and any corresponding key point, i.e., the color, aroma, taste, aftertaste or flavor of the beverage per se, or the smell left in a bottom or rim of the container, is displayed in the secondary area 3 correspondingly. When the icon “−1/2” (see FIG. 11) which indicates the adjustment duration of a half-minute reduction is actuated, the control unit 10 subtracts half a minute from 3 minutes and 30 seconds so as to make the duration for brewing become 3 minutes. When the tea is brewed based on the duration thus shortened, the brewing result will render a thinner taste, and the aroma and color will be lighter, while the taste reveals the basic taste of the tea per se, with the resultant overall taste having a milder level and depth. At this moment, the additional indication data that corresponds to the duration for brewing shortened by the adjustment duration is displayed in the primary area 2, and any corresponding key point are displayed in the secondary area 3 correspondingly.

Referring to FIG. 11, an implementation of an entry of the indication data outputted by the second embodiment of the device 1′ 10 seconds into brewing the tea is illustrated. A description of “At the onset, the aroma of ‘Oriental Beauty’ is prominent, and its special taste makes people possessed-like when waiting.” is displayed in the primary area 2 of the screen. The blocks 31-34 of the secondary area 3 do not appear on the screen.

Referring to FIG. 12, an implementation of an entry of the indication data and a key point outputted by the second embodiment of the device 1′ 60 seconds into brewing the tea is illustrated. A description of “As the hot steam evaporates, the tea liquid with an aroma o ‘zhuo-yan’ (a special aroma) gradually turns to maroon, and the taste becomes stronger increasingly” is displayed in the primary area 2 of the screen. Two key points, “Ruby red” and “Ripe fruit fragrance”, are displayed respectively in the two blocks 31 and 32 of the secondary area 3 of the screen, while the blocks 33 and 34 of the secondary area 3 do not appear on the screen. It should be noted that the aroma of “zhuo-yan” results from tea leaves being bitten by a specific insect, Jacobiasca formosana.

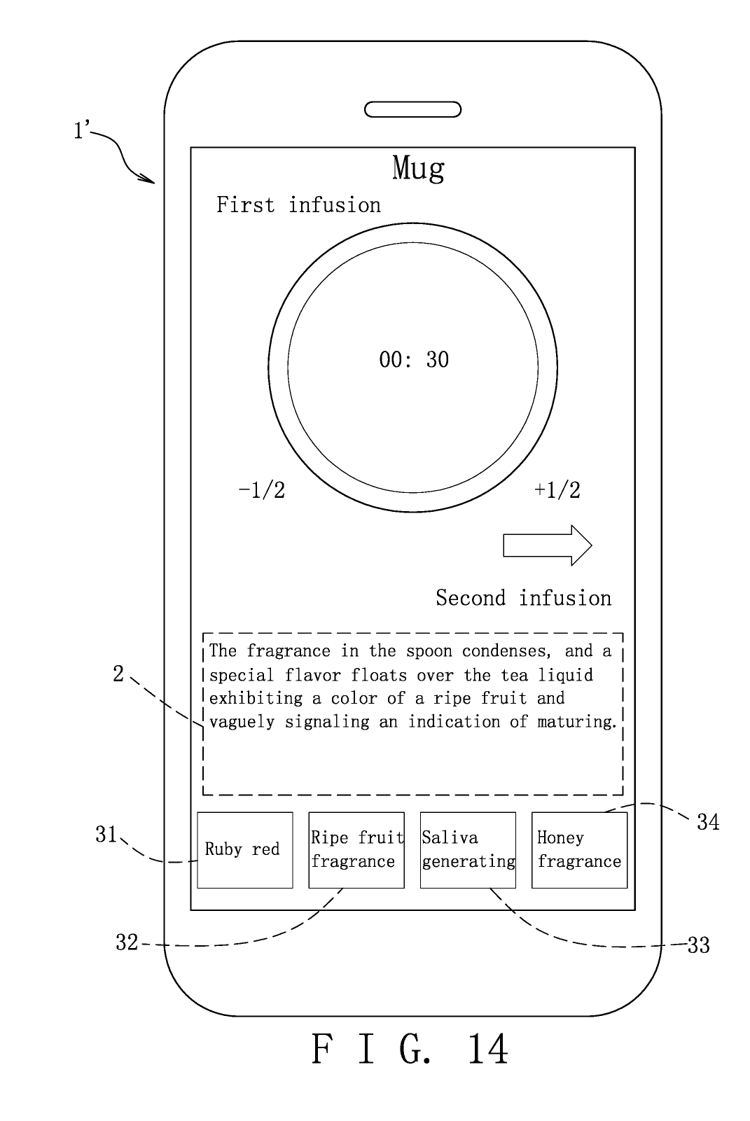

Referring to FIG. 13, an implementation of an entry of the indication data and key points outputted by the second embodiment of the device 1′ 120 seconds into brewing the tea is illustrated. A description of “The user can pick up the mug and move it near his/her nose for sniffing, or after stirring the tea by a porcelain spoon, it is to be picked up and moved close to the nose for smelling the change in aroma as temperature changes.” is displayed in the primary area 2 of the screen. Three key points, “Ruby red”, “Ripe fruit fragrance” and “Saliva generating” are displayed respectively in the three blocks 31-33 of the secondary area 3 of the screen, while the block 34 of the secondary area 3 does not appear on the screen.

Referring to FIG. 14, an implementation of an entry of the indication data and key points outputted by the second embodiment of the device 1′ after 180 seconds into brewing the tea is illustrated. A description of “The fragrance in the spoon condenses, and a special flavor floats over the tea liquid exhibiting a color of a ripe fruit and vaguely signaling an indication of maturing.” is displayed in the primary area 2 of the screen. The key points, “Ruby red”, “Ripe fruit fragrance”, “Saliva generating” and “Honey fragrance” are displayed respectively in the blocks 31- 34 of the secondary area 3 of the screen.

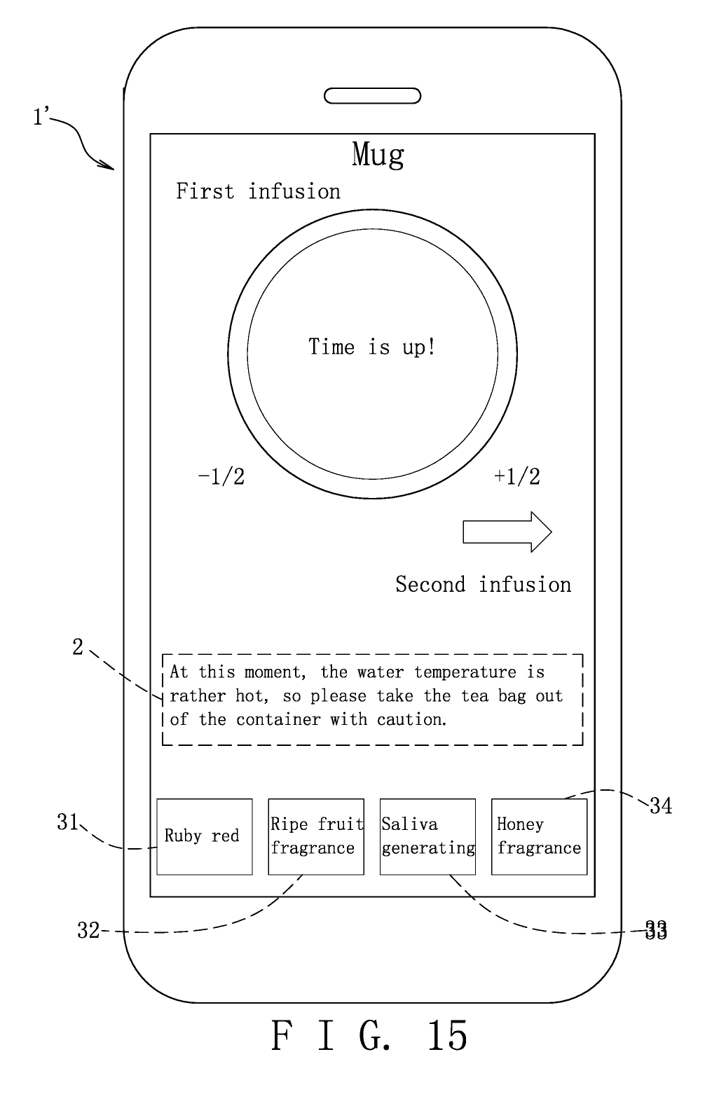

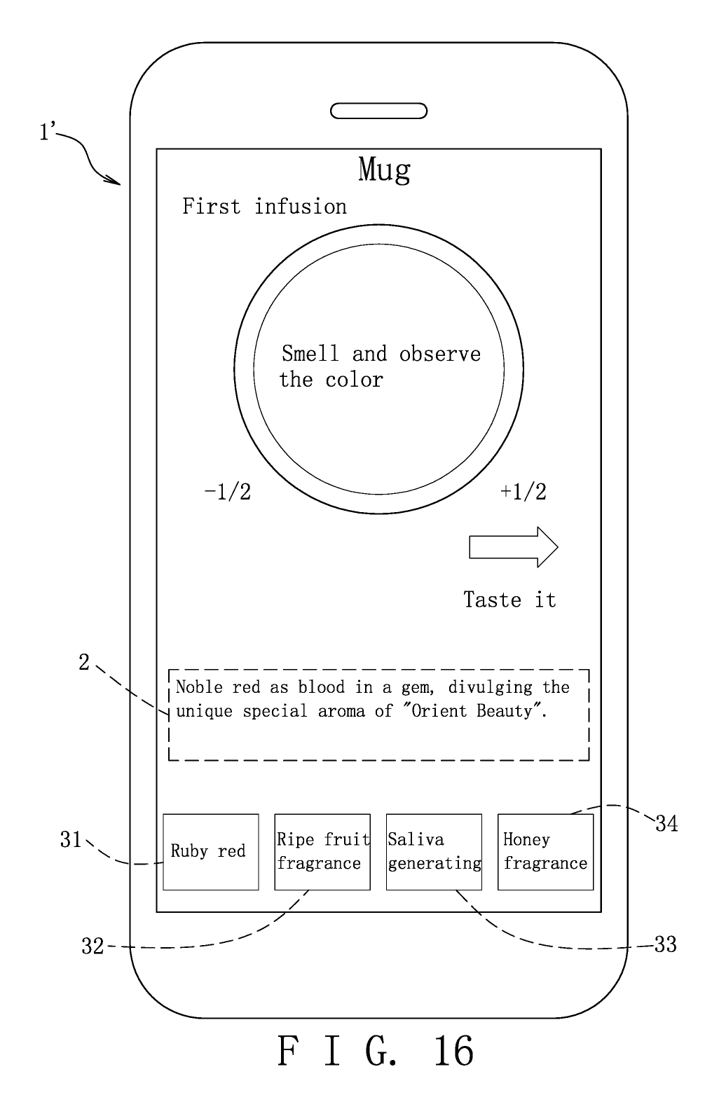

Referring to FIG. 15, an implementation of an entry of the indication data that indicates the duration of three and a half minutes for brewing the tea has elapsed and that is outputted by the second embodiment of the device 1′ 210 seconds into brewing the tea is illustrated. The device 1′ displays “Time is up!” to notify a user of the elapse of the duration. A description of “At this moment, the water temperature is rather hot, so please take the tea bag out of the container with caution.” is displayed in the primary area 2 of the screen so as to advise the user of the same.

Next, examples of operations of the device 1′ after the duration for brewing the tea has elapsed are illustrated.

The storage unit 14 is further configured to store plural entries of commentary data that are associated with instructions on how to consume said at least one kind of beverage or properties of said at least one kind of beverage during a procedure of consuming said at least one kind of beverage. The control unit 10 is further configured to control the timer 11 to measure a time interval after the duration for brewing said at least one kind of beverage has elapsed, and to control, based on the measurement of the time interval, the output unit 12 to output in sequence the plural entries of commentary data when the time interval measured by said timer 11 reaches respective preset time points.

In some embodiments, the key points of the indication data, the plural entries of the indication data, and the plural entries of the commentary data can be implemented to be outputted, accompanied by sounds or vibrations, correspondingly to the primary area 2 and secondary area 3 of the screen, so that users can be notified, without needing to keep paying attention to the device 1, 1′.

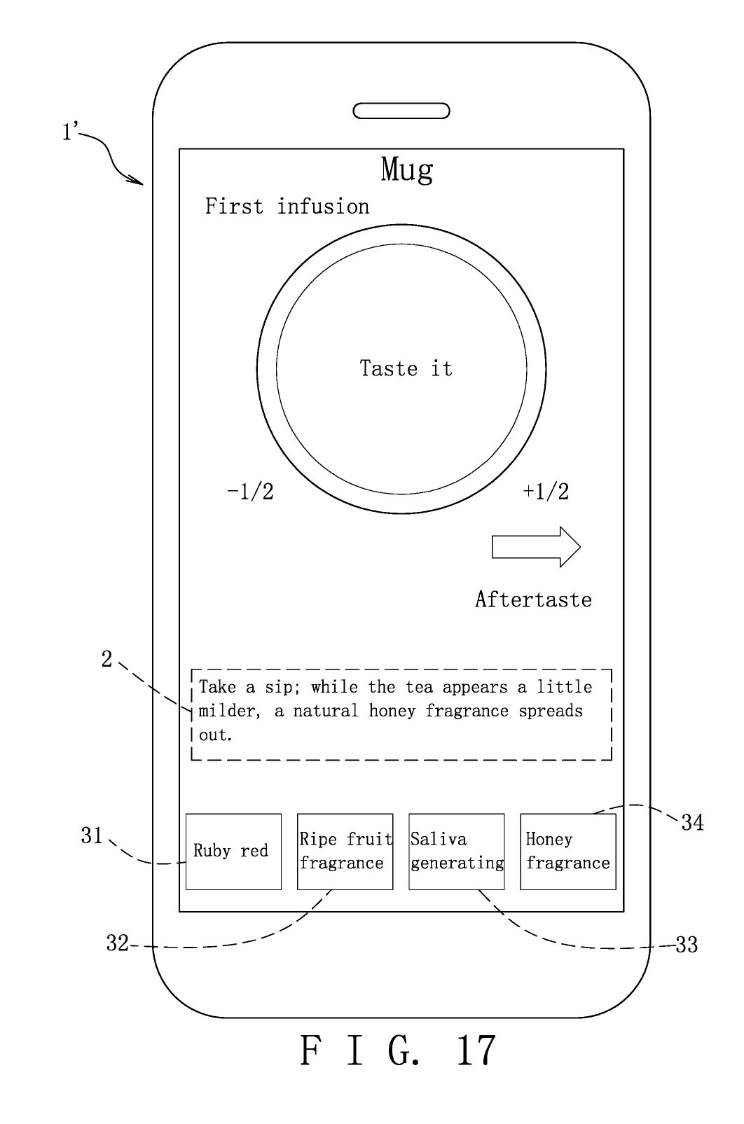

Referring to FIG. 16, an implementation of an entry of commentary data that prompts a user to smell and observe the color of the tea and that is outputted by the second embodiment of the device 215 seconds after the brewing of the tea had started is illustrated. A description of “Noble red as blood in a gem, divulging the unique special aroma of ‘Orient Beauty’.” is displayed in the primary area 2 of the screen and a description of “Smell and observe the color” is displayed in a cup mouth as indicated by a circle shown on the screen so as to provide a supposed perception of the tea.

Referring to FIG. 17, an implementation of an entry of the commentary data that prompts the user to consume the tea and that is outputted by the second embodiment of the device 1′ 245 seconds after the brewing of the tea had started is illustrated. A description of “Take a sip; while the tea appears a little milder, a natural honey fragrance spreads out.” is displayed in the primary area 2 of the screen and a description of “Taste it” is displayed in the cup mouth as indicated by the circle shown on the screen so as to instruct the user to consume the tea.

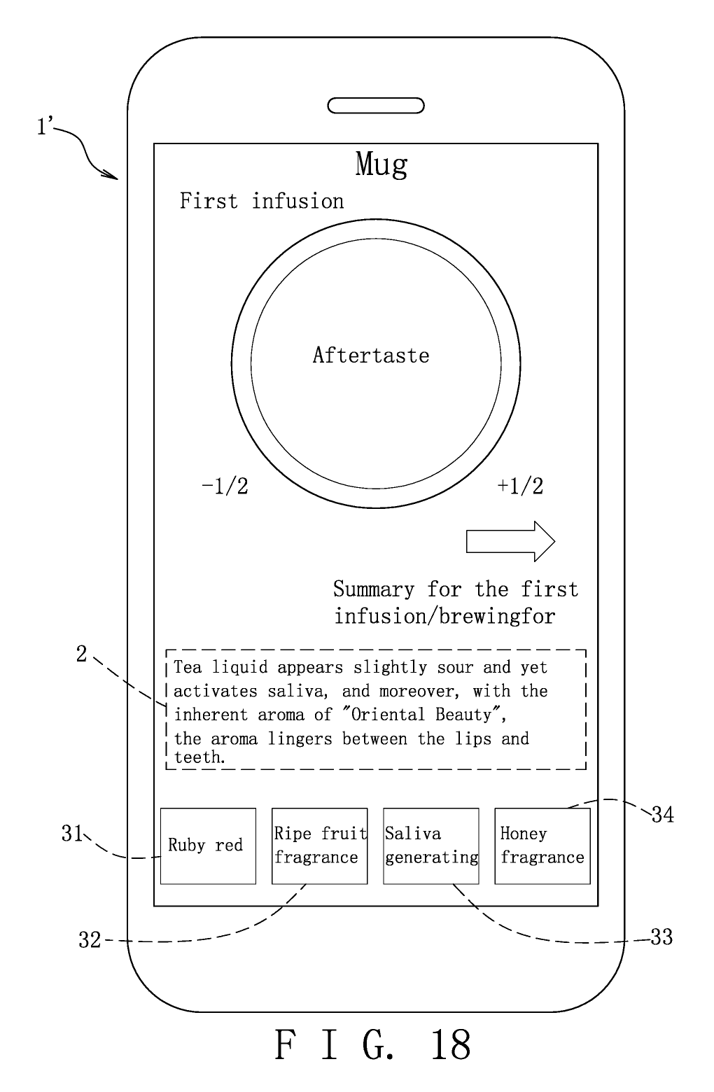

Referring to FIG. 18, an implementation of an entry of the commentary data that prompts the user to appreciate an aftertaste of the tea and that is outputted by the second embodiment of the device 1′ 275 seconds after the brewing of the tea had started is illustrated. A description of “Tea liquid appears slightly sour and yet activates saliva, and moreover, with the inherent aroma of ‘Oriental Beauty’, the aroma lingers between the lips and teeth.” is displayed in the primary area 2 of the screen and a description of “Aftertaste” is displayed in the cup mouth as indicated by the circle shown on the screen so as to provide a supposed perception of the tea.

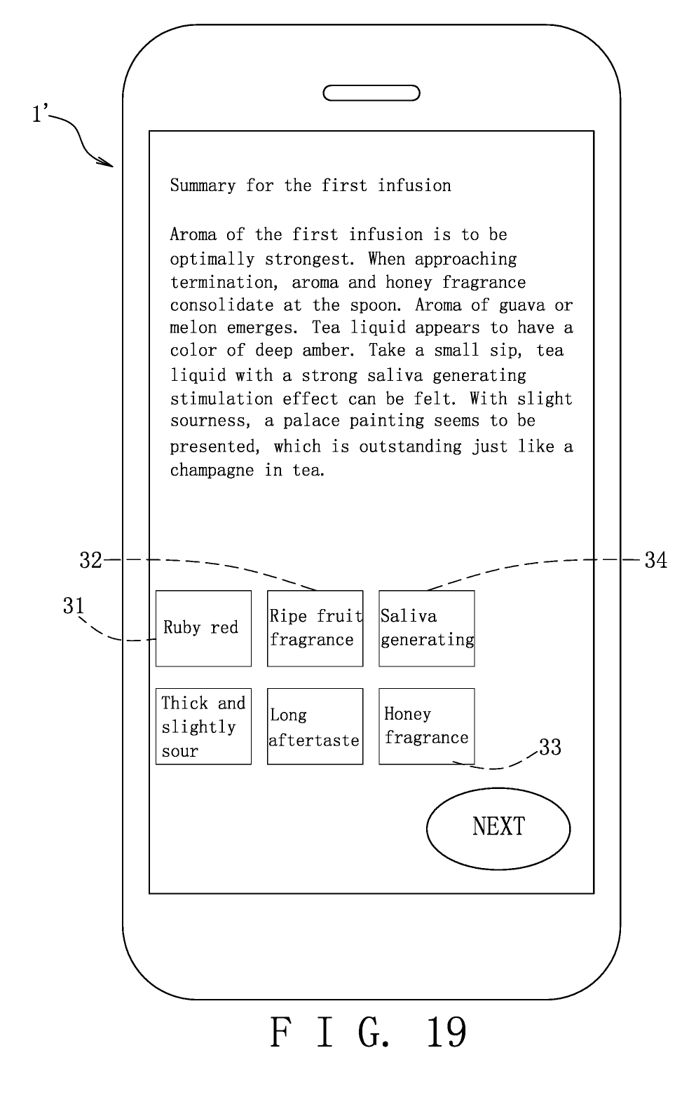

Referring to FIG. 19, an implementation of an entry of the commentary data about the first infusion of the beverage and key points outputted by the second embodiment of the device 1′ is illustrated. A description of “Aroma of the first infusion is to be optimally strongest. When approaching termination, aroma and honey fragrance consolidate at the spoon. Aroma of guava or melon emerges. Tea liquid appears to have a color of deep amber. Take a small sip, tea liquid with a strong saliva generating stimulation effect can be felt. With slight sourness, a palace painting seems to be presented, which is outstanding just like a champagne in tea.” is displayed in the primary area 2 of the screen so as to make a summary about the tea.

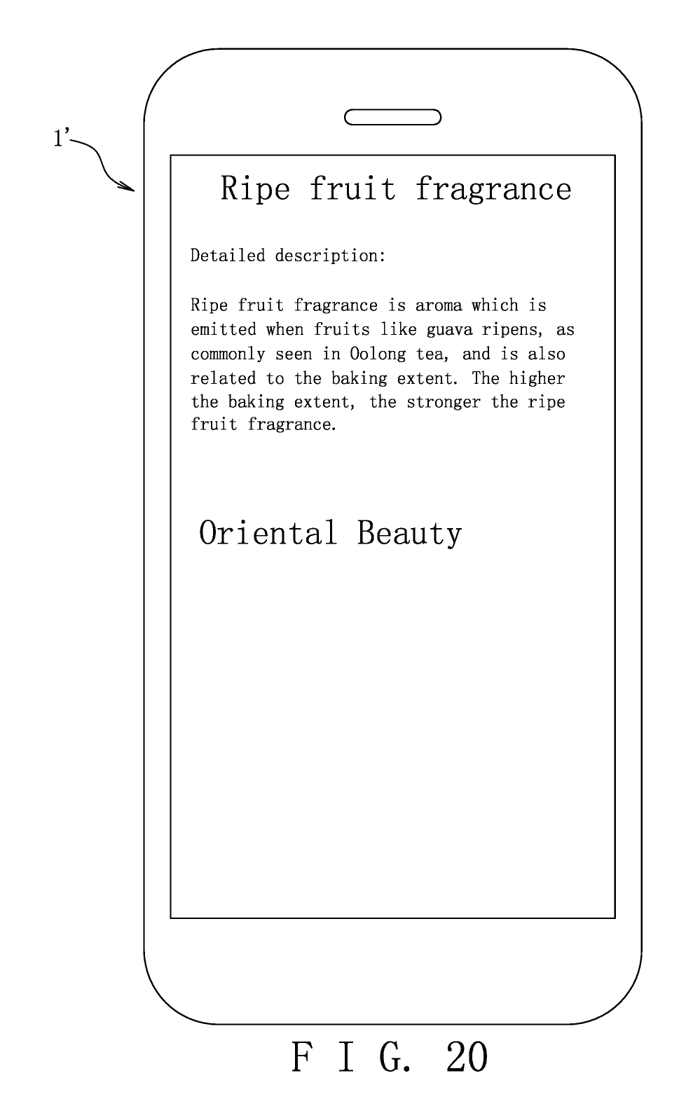

In this embodiment, the storage unit 14 is further configured to store information that is to be outputted by the second embodiment of the device 1′ after one of the key points displayed at a respective block has been selected. As shown in FIG. 20, an implementation of information outputted by the second embodiment of the device 1′ after one of the key points which is labeled “Ripe fruit fragrance” at the block 32 of the secondary area 3 in FIG. 19 has been selected is illustrated.

In the foregoing, the appearance of the beverage and how a user would be expected to feel for each interval of the duration for brewing is illustrated, and how the aroma, color and/or taste of the beverage change is also addressed. As a result, the device 1, 1′ works just as if the user is guided by a professional to experience the enjoyment of tea tasting.

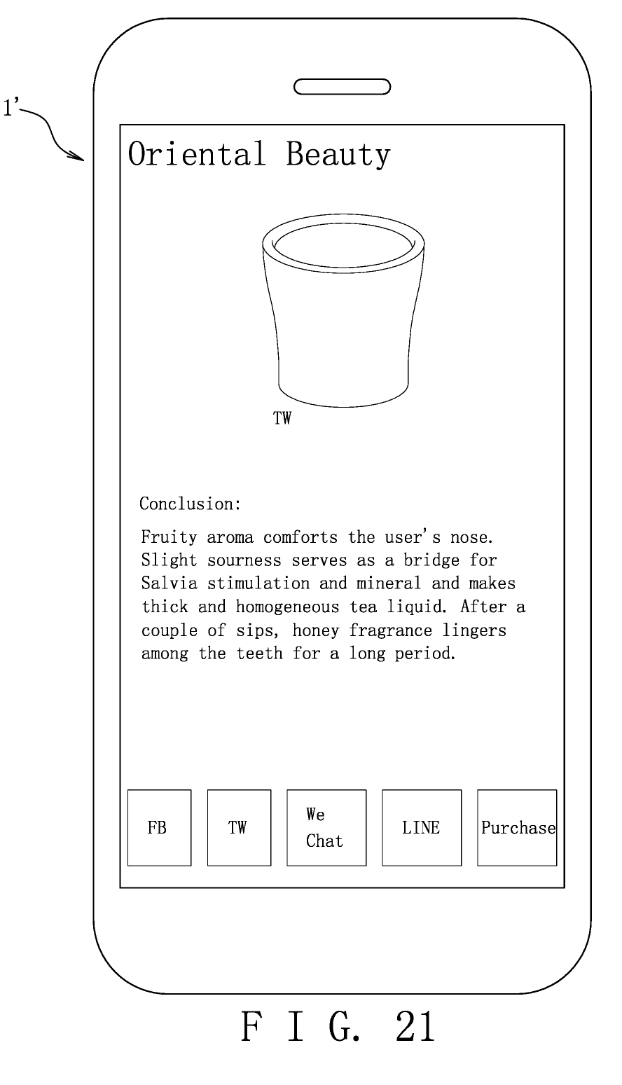

FIG. 21 illustrates an example of an image outputted by the output unit 12 of the second embodiment of the device 1′ at the end of providing the summary about the tea in FIG. 19. The image includes presentation of an entry of the commentary data which is associated with a conclusion about the tea, and includes a hyperlink which leads to one of a social networking site and an online store carrying the tea. Therefore, users can share their experience of the tea at the social networking site or purchase the tea at the online store.

In the following, detailed processes of operating the input unit 13 for editing the timing data, the first/second timing threshold values and the indication data by a dealer or an authorized user are presented. Any entry of the timing data associated with the brewing duration, i.e., the recommended duration for brewing the beverage for each infusion, can be selected to be edited. One entry of timing data associated with the brewing duration and the relevant first/second threshold values are illustrated herein, and the same method can be applied to any other brewing duration as well.

Referring to FIG. 22, when it is desired to edit the first timing threshold values and the corresponding indication data to be displayed in the primary area 2, a tab labeled “Text description” can be selected, and then an area defined by dotted lines beneath the tag “Text” is shown. Next, a time point is entered for a minute field 41 and a second field 42 in units of minute and second (e.g., “0” and “10” respectively) to serve as one of the first timing threshold values, and a text field 43 is filled with a corresponding input text, such as “At the onset, the aroma of ‘Oriental Beauty’ is prominent, and its special taste makes people possessed-like when waiting.” to serve as one of the plural entries of indication data. A check box 44 can be selected for determining whether the input text is used as a part of a conclusive comment for a corresponding infusion of a corresponding beverage. After that, the “ENTER” key is to be selected for showing the aforementioned first timing threshold value and the indication data in a text description table 45, that is, a text field “T1” in FIG. 22. In the meantime, a corresponding input message is presented in a schedule table 40, that is, a tag field “Tag1” in FIG. 22. In the same manner, text content and relevant time points of the subsequent tag fields “Tag 2”, “Tag 3”, etc. can be edited in sequence.

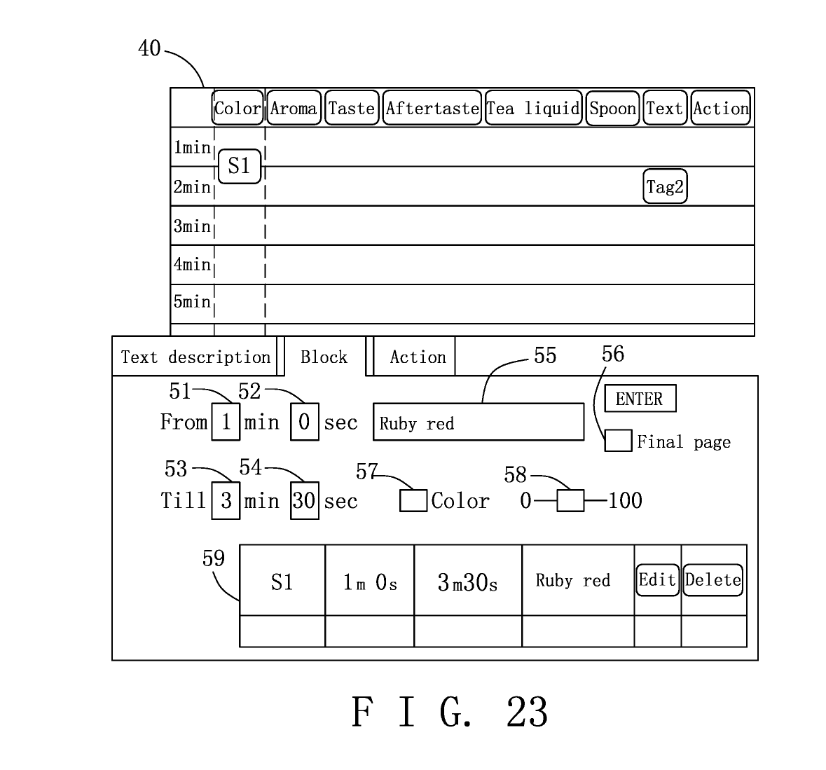

Referring to FIG. 23, when it is desired to edit the second timing threshold values and the content of the corresponding key points to be displayed in the secondary area 3, a tab labeled “Block” is to be selected, then a tag labeled “Color” in the schedule table 40 is selected, and next, an area defined by dotted lines beneath the tag “Color” is shown. A starting time point is entered in a starting minute time field 51 and a starting second time field 52 in the units of minute and second, respectively. For example, “1” and “0” are set in the starting minute time field 51 and the starting second time field 52, respectively, to cooperatively define one of the second timing threshold values. An ending time point is entered in an ending minute time field 53 and an ending second time field 54 in a similar fashion. For example, “3” and “30” are set in the ending minute time field 53 and the ending second time field 54, respectively. A corresponding text is entered in a text field 55, for example, “Ruby red” to serve as a corresponding key point. It should be noted that in some embodiments, a more detailed explanation of one of the key points can be edited herein, so when the one of the key points is selected, information corresponding to the detailed explanation may be outputted as the information shown in FIG. 20. A check box 56 can be selected for determining whether the text in the text field 55 is used as a part of the conclusion comment for a corresponding infusion of the beverage. Furthermore, a color selector box 57 can be operated for selecting the corresponding color of the beverage, and a scroll bar 58 can be moved for adjustment of the saturation of the selected color. Lastly, the “ENTER” key is to be selected for showing the aforementioned second timing threshold value and the key point in a table 59, that is, a text field “S1” in FIG. 23. In the meantime, a corresponding input message is presented in the schedule table 40, that is, a tag field “S1” in FIG. 23. In the same manner, text content and relevant time points of the subsequent tag fields “S2”, “S3”, etc. can be edited in sequence. It should be noted herein that, apart from provision of an interface for editing “Color”, the tab labeled “Block” can also used for editing content related to “Aroma”, “Taste”, “Aftertaste”, “Tea liquid” and “Spoon” by selecting the tags labeled “Aroma”, “Taste”, “Aftertaste”, “Tea liquid” and “Spoon” at the upper area of the schedule table 40 respectively and correspondingly.

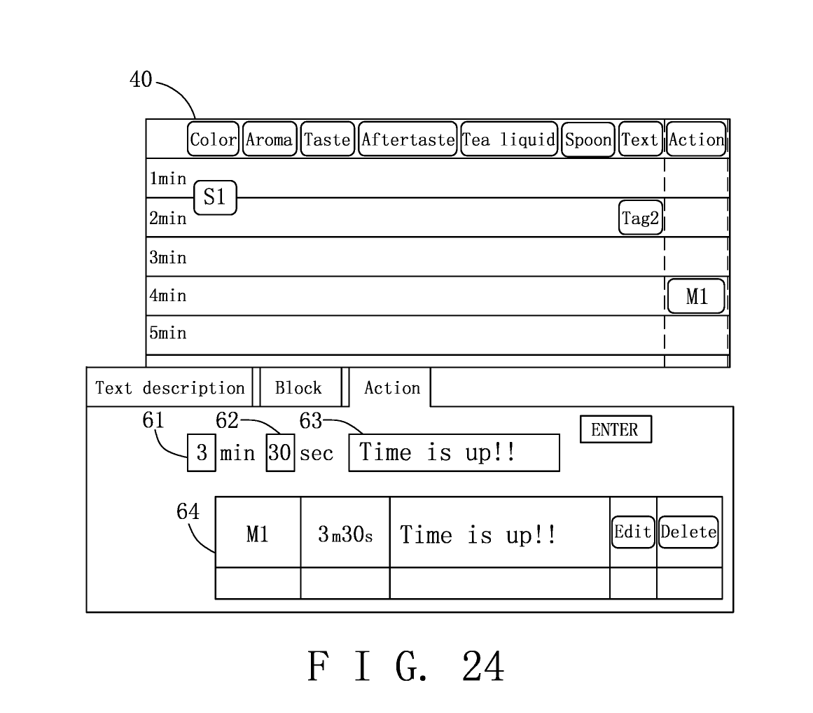

Referring to FIG. 24, when it is desired to edit different timing points and the content of the corresponding entries of commentary data that are associated with the instructions on how to consume said at least one kind of beverage or properties of said at least one kind of beverage during the procedure of consuming said at least one kind of beverage, a tab labeled “Action” can be selected, and then an area defined by dotted lines beneath the tag “Action” is shown. Next, a time point may be entered for a minute field 61 and a second field 62 to serve as a time point (e.g., 3 minutes 30 seconds) for display of the corresponding commentary data, and a text field 63 is filed with a corresponding input text, such as “Time is up!” to serve as the corresponding commentary data. After that, the “ENTER” key is to be selected for showing the aforementioned time point and the commentary data in a text description table 64, that is, a field “M1” in FIG. 24. In the meantime, a corresponding input message is presented in the schedule table 40, that is, a tag field “M1” in FIG. 24. In the same manner, text content and relevant time points of the subsequent actions “M2”, “M3”, etc. can be edited for prompting the user to conduct the actions of “Smelling the fragrance and Watching the color”, “Taste”, “Aftertaste”, etc. in sequence.

In summary, the device for assisting in brewing a beverage of this disclosure controls, via the control unit based on the timing data stored in the storage unit, the timer to measure the time interval of the procedure of brewing the beverage, and controls, via the control unit based on measurement of the time interval, the output unit to output the timing result generated by the timer. In addition, the device controls the output unit to output in sequence, at the primary area of the screen of the output unit, plural entries of indication data that are stored in the storage unit, that are associated with the procedure of brewing the beverage, and that include information of purported visual and gustatory perceptions of the beverage at different stages during the procedure of brewing when the time interval measured by the timer reaches the respective first timing threshold values. Moreover, the device controls the output unit to output in sequence, at the blocks of the secondary area of the screen of the output unit, the key points that are associated with at least one of the color, aroma, taste or aftertaste of the beverage per se, or the texture of the tea liquid, or the smell left in the container when the time interval measured by the timer reaches the respective second timing threshold values. Furthermore, the device controls the output unit to output in sequence the plural entries of the commentary data when the time interval measured by the timer reaches the respective preset time points. As a consequence, users can be assisted by the device to brew and to enjoy the beverage. Last but not least, the input unit allows the users, when permissible, to edit at least one of the timing data, the first/second timing threshold values, the indication data, the commentary data, the key points, or the shade of color or brightness of the blocks of the secondary area.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A device for assisting in brewing a beverage, said device comprising:
a control unit;
a timer electrically connected to said control unit, and being controlled by said control unit to measure a time interval so as to generate a timing result of measurement of the time interval;
an output unit electrically connected to said control unit, and being controlled by said control unit to output the timing result; and
a storage unit electrically connected to said control unit, and configured to store timing data that is associated with at least one duration for brewing at least one kind of beverage, and plural entries of indication data that are associated with properties of said at least one kind of beverage during a procedure of brewing said at least one kind of beverage, and that include information of purported visual and gustatory perceptions of said at least one kind of beverage at different stages during the procedure of brewing;
wherein said control unit is configured to control, based on the timing data, said timer to measure the time interval during the procedure of brewing said at least one kind of beverage, and to control, based on the measurement of the time interval, said output unit to output the timing result, and to output in sequence the plural entries of indication data that are associated with the procedure of brewing said at least one kind of beverage.

2. The device as claimed in claim 1, further comprising:
an input unit electrically connected to said control unit;
wherein said control unit is further configured to receive a user input which is inputted via said input unit, and to edit, via an editing interface, the timing data and the plural entries of indication data stored in said storage unit based on the user input.

3. The device as claimed in claim 2, wherein:
said storage unit is further configured to store an adjustment duration; and
said input unit is configured to be operated to enable said control unit to access the adjustment duration, and to add the adjustment duration to the duration for brewing said at least one kind of beverage to serve as the timing data.

4. The device as claimed in claim 3, wherein said storage unit is further configured to store additional indication data that corresponds to the duration for brewing said at least one kind of beverage extended by the adjustment duration.

5. The device as claimed in claim 2, wherein:
said storage unit is further configured to store an adjustment duration; and
said input unit is configured to be operated to enable said control unit to access the adjustment duration, and to subtract the adjustment duration from the duration for brewing said at least one kind of beverage to serve as the timing data.

6. The device as claimed in claim 5, wherein said storage unit is further configured to store additional indication data that corresponds to the duration for brewing said at least one kind of beverage shortened by the adjustment duration.

7. The device as claimed in claim 1, said at least one kind of beverage being plural in kind, wherein:
said storage unit is further configured to store plural entries of beverage data that are respectively associated with the plural kinds of beverages; and
said control unit is further configured to, for each entry of the beverage data, control said output unit to output information of suggested containers corresponding to the entry of the beverage data.

8. The device as claimed in claim 7, wherein:
said storage unit is further configured to store plural entries of container data that are associated respectively with the suggested containers, which are different in terms of at least one of material, capacity, or factors related to heat transfer; and
said control unit is further configured to control said output unit to output, for a selected one of the plural kinds of beverage, each entry of the container data associated with the suggested containers, in combination with a corresponding entry of the timing data.

9. The device as claimed in claim 1, wherein:
said output unit includes a screen configured to display each of the plural entries of indication data on a primary area of said screen;
said storage unit is further configured to store a plurality of first timing threshold values corresponding respectively to the different stages during the procedure of brewing and corresponding respectively to the plural entries of indication data; and
when it is determined that the time interval measured by said timer has reached one of the first timing threshold values, said control unit is further configured to control said screen to display a corresponding one of the plural entries of indication data on the primary area of the screen.

10. The device as claimed in claim 9, wherein each of the plural entries of indication data displayed on the primary area of the screen is presented in a manner of at least one of text, a figure or a motion picture.

11. The device as claimed in claim 1, wherein:
said output unit includes a screen configured to display a key point of one of the plural entries of indication data on a secondary area of the screen, the secondary area including a plurality of blocks that are separated from each other;
said storage unit is further configured to store a plurality of second timing threshold values corresponding respectively to the different stages during the procedure of brewing and corresponding respectively to the plural entries of indication data; and
when it is determined that the time interval measured by said timer has reached one of the second timing threshold values, said control unit is further configured to control said screen to display the key point of a corresponding one of the plural entries of indication data on one of the blocks of the secondary area of the screen, the key point displayed on each of the blocks including at least one of description of a color of the beverage, description of an aroma of the beverage, description of a taste of the beverage, description of an aftertaste of the beverage, description of a texture of the beverage, or description of a smell left in a container for containing the beverage.

12. The device as claimed in claim 11, wherein the key point displayed on the secondary area of the screen is presented in a manner of at least one of text, a figure or a motion picture.

13. The device as claimed in claim 11, further comprising:
an input unit electrically connected to said control unit;
wherein said control unit is further configured to receive a user input which is inputted via said input unit, and to edit, via an editing interface, the key point of each of the plural entries of indication data to be displayed on a secondary area of the screen based on the user input.

14. The device as claimed in claim 1, wherein:
said output unit is a screen configured to display key points of the plural entries of indication data on a secondary area of the screen, the secondary area including a plurality of blocks that are separated from each other for display of the respective key points;
said storage unit is further configured to store a plurality of second timing threshold values corresponding respectively to the different stages during the procedure of brewing; and
when it is determined that the time interval measured by said timer has reached one of the timing threshold values, said control unit is further configured to control said screen to adjust a shade of color or brightness of at least a corresponding one of the blocks of the secondary area of the screen.

15. The device as claimed in claim 14, further comprising:
an input unit electrically connected to said control unit;
wherein said control unit is further configured to receive a user input which is inputted via said input unit, and to edit, via an editor interface, the shade of color or brightness of each of the blocks of the secondary area of the screen based on the user input.

16. The device as claimed in claim 1, wherein the timing data includes a plurality of recommended durations for brewing said at least one kind of beverage, each of the plurality of recommended durations corresponding to a respective infusion of a predetermined amount of said at least one kind of beverage.

17. The device as claimed in claim 1, wherein said output unit is further configured to output at intervals a description associated with at least one of an appearance of said at least one kind of beverage and a supposed perception of said at least one kind of beverage.

18. The device as claimed in claim 1, wherein said output unit is further configured to output an image that includes a hyperlink which leads to one of a social networking site and an online store associated with said at least one kind of beverage.

19. The device as claimed in claim 1, wherein said output unit includes at least one of a video playback device and an audio playback device.

20. The device as claimed in claim 1, wherein:
said storage unit is further configured to store plural entries of commentary data that are associated with instructions on how to consume said at least one kind of beverage or properties of said at least one kind of beverage during a procedure of consuming said at least one kind of beverage; and
said control unit is further configured to control said timer to measure a time interval after the duration for brewing said at least one kind of beverage has elapsed, and to control, based on the measurement of the time interval, said output unit to output in sequence the plural entries of commentary data when the time interval measured by said timer reaches respective preset time points.

21. The device as claimed in claim 20, further comprising:
an input unit electrically connected to said control unit;
wherein said control unit is further configured to receive a user input which is inputted via said input unit, and to edit, via an editing interface, the plural entries of commentary data stored in said storage unit based on the user input.
